(19) United States
(12) Patent Application Publication
(10) Pub. No.: US 2026/0238372 A1
(43) Pub. Date: Aug. 13, 2026

(54) Free Space Optics Network

(71) Applicant: Telefonaktiebolaget LM Ericsson (publ), Stockholm (SE)

(72) Inventors: Giacomo Manzato, Genova (IT); Stefano Orsi, Genova (IT); Roberto Magri, Genova (IT); Paolo Debenedetti, Genova (IT)

(21) Appl. No.: 19/154,651

(22) PCT Filed: Feb. 10, 2023
(86) PCT No.: PCT/EP2023/053400

§ 371 Date: Aug. 7, 2025

(51) Int. Cl. H04J 14/02; H04B 10/11

(52) U.S. Cl. CPC H04J 14/0241; H04B 10/11

(57) ABSTRACT

The present application relates to a free space optical, FSO, network node configured to receive and/or transmit a first FSO signal comprising a plurality of wavelengths, the FSO network node comprising an optical element configured to receive the first FSO signal from within a defined angular range; a first optical device configured to select a first subset of wavelengths from the plurality of wavelengths of the first FSO signal; and a first optical module configured to receive the first subset of wavelengths from the first optical device. The present application also relates to a method performed by an FSO network node, a method of calibrating an FSO network node and an FSO network.

### TECHNICAL FIELD

The present application relates to a free space optical (FSO) network node, a method performed by an FSO network node, a method of calibrating an FSO network node and an FSO network.

### BACKGROUND

The development of 5G and 6G radio access networks (RAN) are expected to provide high-capacity support for both temporary and permanent communications requirements in indoor and outdoor environments, for example at temporary events, such as concerts and sporting events.

Existing solutions for indoor communications may use specific indoor radio units. However, in such systems, it is important to install the radio units in a particular position according to the layout and structure of the building, to take account of walls, obstacles, intended user distribution and propagation characteristics of the intended coverage area. Existing point-to-point communication technology includes the use of microwave (MW) links, but these are not appropriate for use in an indoor environment. Moreover, the availability of wired backhaul connections may require civil works and dedicated wiring which might be unfeasible or aesthetically unacceptable.

Existing solutions for external communications may use a range of technologies, depending on the intended coverage area. One example may involve the use of MW links and optical fibres to achieve point-to-point communications. However, may not be cost effective to use MW links in a temporary outdoor event, due to licensing costs and antenna alignment requirements, for example.

Wireless optical connections, such as free space optics (FSO), has been envisaged as an alternative to MW links for relatively short distance (e.g., up to around 200 m) point-to-point communications. However, known FSO systems rely on point-to-point collimated laser beam connections, and so are impacted by high costs (e.g., lens tracking mechanisms to maintain accurate aiming of the laser beam) and line-of-sight limitations between nodes in the FSO link.

There is therefore a desire for an alternative communication mechanism that is relatively inexpensive to install, and which helps to mitigate at least some of the above-identified issues.

### SUMMARY

Examples according to the present disclosure therefore aim to provide a free space optical (FSO) network node, a method performed by an FSO network node, a method of calibrating an FSA network node and an FSO network that at least partially address one or more of the challenges discussed above.

For example, the present disclosure provides a mechanism by which relatively low-cost components may be used to communicate with one another in an FSO network. The FSO network nodes disclosed herein make use of one or more optical elements, such as lenses, which remove the need for accurate aiming and alignment to enable adjacent nodes in an FSO network to communicate with one another.

According to a first aspect there is provided a free space optical, FSO, network node configured to receive and/or transmit a first FSO signal comprising a plurality of wavelengths, the FSO network node comprising an optical element configured to receive the first FSO signal from within a defined angular range; a first optical device configured to select a first subset of wavelengths from the plurality of wavelengths of the first FSO signal; and a first optical module configured to receive the first subset of wavelengths from the first optical device.

According to a second aspect there is provided a method performed by a free space optic, FSO, network node, the FSO network node having an optical element, a first optical device and a first optical module, the method comprising receiving a first FSO signal comprising a plurality of wavelengths; directing, using the optical element, the first FSO signal towards the first optical device; selecting, using the first optical device, a first subset of wavelengths from the plurality of wavelengths of the first FSO signal; and receiving the first subset of wavelengths at the first optical module.

According to a third aspect there is provided a method of calibrating a free space optical, FSO, network node according as disclosed herein, the method comprising receiving a first sample FSO signal comprising a first set of sample wavelengths; determining whether there exists interference, exceeding a threshold interference amount, between the first set of sample wavelengths and a set of wavelengths intended to be used by the FSO network node; responsive to determining that there does not exist interference exceeding the threshold interference amount, sending an instruction to the first optical device such that the first optical device is to select the first set of sample wavelengths from received FSO signals.

According to a fourth aspect there is provided free space optical, FSO, network comprising a first FSO network node as disclosed herein; and a second FSO network node as disclosed herein.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a schematic illustration of functional modules in an example of an FSO network node;

FIG. 2 is a block diagram illustrating functional modules in an example optical module;

FIG. 3 is a schematic illustration of functional modules in a further example of an FSO network node;

FIG. 4 is a schematic illustration of a first example of an optical network;

FIG. 5 is a schematic illustration of a second example of an optical network;

FIG. 6 is a schematic illustration of a third example of an optical network;

FIG. 7 is a flowchart illustrating process steps in an example of a method performed by a FSO network node;

FIG. 8 is a flowchart illustrating process steps in a further example of a method performed by a FSO network node;

FIG. 9 is a flowchart illustrating process steps in an example of a method of calibrating an FSA network node; and

FIG. 10 is a flowchart illustrating process steps in an example of a method of calibrating an optical unit.

### DETAILED DESCRIPTION

The present disclosure provides a mechanism that enables point-to-point and point-to-multiple-point communications to be made in a way that is cost effective and has less stringent requirements with regard to accurately directing a signal from one node to another. More specifically, the disclosure relates to a free space optics (FSO) network arrangement that utilises wavelength division multiplexing (WDM) technology in the transmission of FSO signals between nodes in an optical network (e.g., an FSO network).

The inventors of the present disclosure have recognised that an FSO signal or multiple multiplexed FSO signals can be transmitted from one node of an optical network via one or more wavelengths or one or more ranges of wavelengths/wavebands to another node of the optical network by making use of an optical element, such as a lens, to direct the FSO signals. For example, on the transmitter side, an FSO signal may be deflected, refracted and/or collimated by a lens located at a node of the network such that the FSO signal is transmitted over a relatively broad angular range. On the receiver side, an FSO signal received at a node of the network may be collimated and directed by a lens towards components of the node that are configured to process the signal. As discussed in greater detail below, such components may include a filter for filtering out wavelengths from the FSO signal and a receiving module (e.g., a transceiver) for receiving the filtered signal.

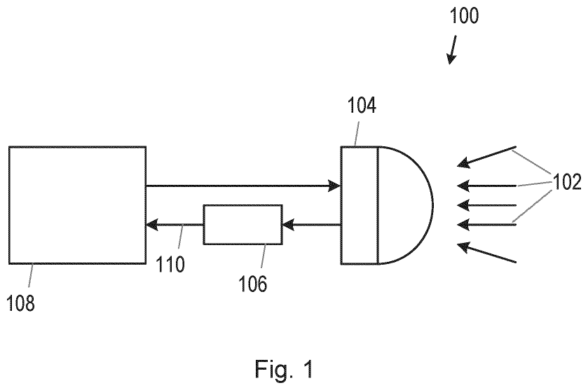

With reference to the drawings, FIG. 1 is a block diagram illustrating functional modules in an example FSO network node 100. The FSO network node 100 is configured to receive and/or transmit a first FSO signal 102 comprising a plurality of wavelengths (e.g., a signal comprising a plurality of wavelengths that have been multiplexed using WDM methods). The network node 100 comprises an optical element 104, a first optical device 106 and a first optical module 108. The optical element 104 is configured to receive the first FSO signal 102 from within a defined angular range. In other words, the optical element may receive the first FSO signal 102 from any direction within the defined angular range which may, for example, comprise a range of 120 degrees. The optical element 104 may, in some examples, be configured to direct the first FSO signal 102 towards the first optical device 106. The optical element 104 may, for example, comprise a lens, such as a lens configured to direct and/or collimate the first FSO signal 102. The first optical device 106 is configured to select a first subset 110 of wavelengths from the plurality of wavelengths of the first FSO signal. The first optical module 108 is configured to receive the first subset 110 of wavelengths from the first optical device 106.

The first optical device 106 may comprise a configurable wavelength selector. Such a wavelength selector may be configured to select a defined wavelength or subset of wavelengths. In some examples, the first optical device 106 may remove unselected wavelengths from the plurality of wavelengths and, as such, may comprise, or may have functionality of, a filter.

The example FSO network node 100 shown in FIG. 1 is configured for receiving the first FSO signal 102 from anywhere within a defined angular range of the optical element 104, and directing the first FSO signal towards the first optical device 106, which selects a subset of wavelengths (e.g., those wavelengths that can be received by the first optical module 108). In this example, the optical module 108 is used for receiving the first subset 110 or wavelengths and, as such, the optical module 108 may, in some examples, comprise a receiving module. In other examples, however, the optical module 108 may comprise a transceiver, capable of receiving and transmitting wavelengths.

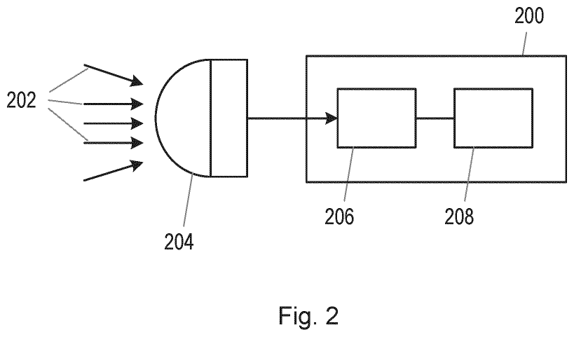

According to some examples, the first optical device 106 and the first optical module 108 may form part of an optical unit, such as a pluggable optical unit, or pluggable module, that can be removably connected to the optical element 104 and/or to a radio station or radio node to provide fronthaul or backhaul optical connectivity. FIG. 2 is a block diagram illustrating functional modules in an example optical unit 200 which, in some examples, may comprise a pluggable optical unit. The optical unit 200 is configured to be connected to a wireless communication network. The optical model 200 is configured to receive and/or transmit an FSO signal 202 comprising a plurality of wavelengths via an optical element 204. The FSO signal 202 may comprise or be similar to the first FSO signal 102 discussed above. The optical element 204, which may comprise or be similar to the optical element 104 discussed above, is configured to receive the FSO signal 202 from within a defined angular range. In some examples, the optical element 104 may be configured to direct the received FSO signal 202 towards the optical unit 200. The optical unit 200 comprises an optical device 206 configured to select a first subset of wavelengths from the plurality of wavelengths of the FSO signal. Thus, the optical device 206 may comprise or be similar to the first optical device 106 discussed above. The optical unit 200 also comprises an optical module 208 configured to receive the first subset of wavelengths from the optical device 206. The optical module 208 may comprise or be similar to or form part of the first optical module 108 discussed above.

The first optical device 106 and/or the optical device 206 may be configurable (e.g., remotely configurable), such that the wavelengths that either optical device can select from the plurality of wavelengths of the first FSO signal 102 or the FSO signal 202 can be accurately chosen. In some examples, the wavelength/frequency that an optical device can select may be changed using remote commands, or using automatic procedures. In this way, the first optical device 106 and/or the optical device 206 may be used to select wavelengths from the plurality of wavelengths that are not being used nearby or by other components of the FSO network node 100 or by other optical units 200. Similarly, the first optical module 108 and/or the optical module 208 may be configurable, such that they are configured to receive the wavelengths that are selected by the first optical device 106 and/or the optical device 206.

The wireless communication network may, for example, comprise a third Generation Partnership Project (3GPP) radio communication network that includes radio equipment, such as radio base stations, radio units, baseband units, indoor radio unts (IRUs), and the like.

In some examples, the optical module 208 of the optical unit 200 may be further configured to transmit a second set of wavelengths via the optical element 204, as is discussed in greater detail below.

In some scenarios, a single optical unit 200 may be connected to an optical element 104 to function within a wireless communication network. However, in other cases, it may be beneficial to have multiple optical units 200 connected to the same optical element, so that signals comprising different wavelengths in the plurality of wavelengths can be received.

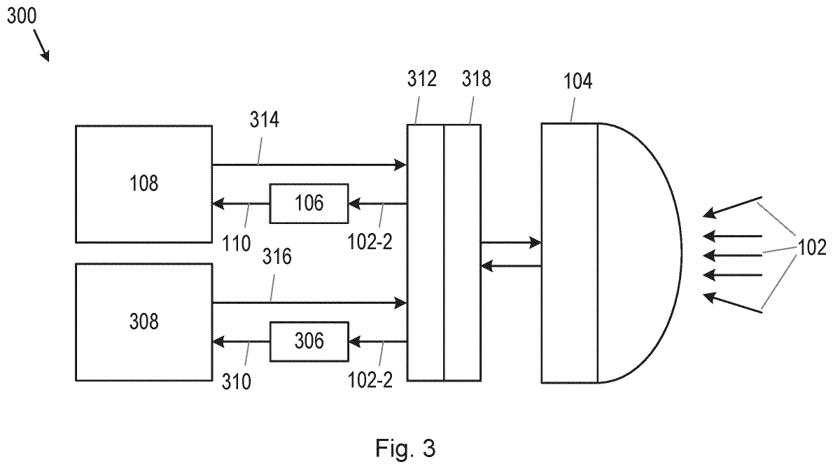

FIG. 3 is a schematic illustration of functional modules in a further example of an FSO network node 300. The FSO network node 300 includes the optical element 104, the first optical device 106 and the first optical module 108. In addition, the FSO network node 300 comprises a second optical device 306 and a second optical module 308. The second optical device 306 is configured to select a second subset 310 of wavelengths from the plurality of wavelengths of the first FSO signal. The second optical module 308 is configured to receive the second subset 310 of wavelengths. While the example shown in FIG. 3 includes two optical devices 106, 306 and two optical modules 108, 308, it will be understood that, in other examples, an FSO network node may comprise more optical devices and optical modules, such as a third optical device and a third optical module.

As with the first optical device 106, the second optical device 306 may comprise a configurable wavelength selector. The second optical device 306 may for example be configured to select a defined wavelength of subset of wavelengths and/or may function as a filter to remove unwanted wavelengths from the plurality of wavelengths.

While the first optical device 106 and the first optical module 108 may form part of a first optical unit 200, the second optical device 306 and the second optical module 308 may form part of a second optical unit. As noted above, an optical unit (e.g., the first and second optical units) may be pluggable units capable of being individually connected to and removed from an optical element (e.g., a lens) and/or a radio station to enable communications over the wireless communication network, so that more signals having different wavelengths of the plurality of wavelengths can be received at the FSO network node. For example, a third optical module may be plugged into the network node 300 to enable a third subset of wavelengths to be received, the third subset of wavelengths being different from the subsets of wavelengths received by the first optical module 108 and the second optical module 308.

In some examples, the network node 300 may further comprise a signal splitter 312 configured to split the first FSO signal 102 into a first split FSO signal 102-1 to be acted upon by the first optical device 106 and a second split FSO signal 102-2 to be acted upon by the second optical device 306. The signal splitter 312, which may comprise an optical splitter, or beam splitter, may be configurable (e.g., remotely configurable, manually or automatically) to split the first FSO signal 102 into N split signals, where N is the number of optical modules in the FSO network node 300. In other words, if the network node 300 includes four optical modules, then the signal splitter 312 may be configured to split the incoming first FSO signal 102 into four split signals.

So far, the optical modules 108, 308 have been discussed in terms of their ability to receive signals. However, the first optical module 108 and/or the second optical module 308 may further be configured to transmit signals or subsets of wavelengths for receipt at a different FSO network node. For example, the first optical module 108 may be configured to transmit a third subset 314 or wavelengths via the optical element 104. The third subset 314 of wavelengths transmitted by the first optical module 108 may comprise the same wavelengths as those in the first subset 110 of wavelengths received by the first optical module. In other words, the first optical module 108 may be configured to receive and transmit the same subset of wavelengths.

Similarly, in examples in which multiple optical modules are provided in an FSO network node, other optical modules may also be configured to transmit subsets of wavelengths. For example, the second optical module 308 may be further configured to transmit a fourth subset 316 of wavelengths. The fourth subset 316 of wavelengths transmitted by the second optical module 308 may comprise the same wavelengths as, or different wavelengths to, those in the second subset 310 of wavelengths received by the second optical module 308. In other words, the second optical module 308 may be configured to receive and transmit the same subset of wavelengths.

The FSO network node 300 may further comprise a multiplexing module 318 configured for multiplexing the third subset of wavelengths and the fourth subset of wavelengths to form a multiplexed signal. The multiplexing module 318 may be further configured for transmitting the multiplexed signal via the optical element. In some examples, the multiplexing module 318 and the signal splitter 312 may form part of the same component. Thus, two distinct subsets of wavelengths may be transmitted by the first and second optical modules, and the subsets of wavelengths are multiplexed by the multiplexing module 318, before the multiplexed signal is directed away from the FSO network node 300 by the optical element 104. In examples in which the FSO network node 300 comprises more optical modules (e.g., M optical modules), then M subsets of wavelengths may be multiplexed by the multiplexing module 318.

The optical element 104 may comprise a lens or multiple lenses. In some examples, optical element 104 may comprise a wide-angle lens, which may have a high numerical aperture. For example, the lens may have angular range of up to 120 degrees. In some examples, multiple optical elements 104 may be provided, such as a plurality of lenses, in order to provide coverage over an even greater angular range.

A network (e.g., an FSO network) may be formed using a plurality of the FSO network nodes 100, 300 discussed above. In an example, an FSO network comprises a first FSO network node 100, 300 as described herein, and a second FSO network node 100, 300 as described herein. More network nodes 100, 300 may be added to the FSO network depending on the requirements of the network and the structures in the area where the FSO network is to be implemented.

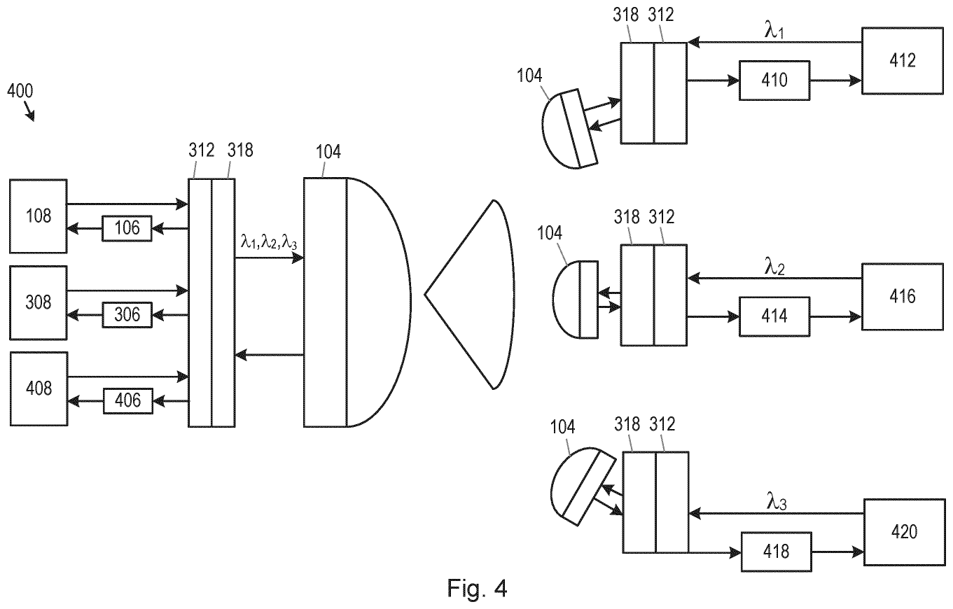

FIG. 4 is a schematic illustration of an example of an FSO network 400. In this example, the FSO network 400 comprises a first FSO network node 402, a second FSO network node 404, a third FSO network node 406 and a fourth FSO network node 408. Each of the FSO network nodes 402, 404, 406, 408 is similar in construction to the FSO network node 100, 300 discussed above, but in this example, the first FSO network node 402 is configured to function as a hub node having three optical modules, each configured to receive and transmit a different subset of wavelengths, and each of the FSO network nodes 404, 406, 408 is configured to function as a spoke node, each having a single optical module configured to receive and transmit one of the three subsets of wavelengths handled by the first FSO network node 402.

Specifically, the first FSO network node 402 comprises the optical element 104, the splitter 312, the multiplexor 318, the first optical module 108 configured to receive a first subset of wavelengths (labelled in this example as λ₁) via the first optical device 106, the second optical module 308 configured to receive a second subset of wavelengths (labelled in this example as λ₂) via the second optical device 306, and a third optical module 408 configured to receive a third subset of wavelengths (labelled in this example as λ₃) via a third optical device 406. Subsets of wavelengths transmitted by the first, second and third optical modules 108, 308, 408 are multiplexed by the multiplexor 318, such that the multiplexed signal transmitted via the optical element 104 includes all three subsets of wavelengths λ₁, λ₂ and λ₃. The multiplexed signal is distributed by the optical element 104 (e.g., a wide-angle lens), such that any FSO network node within the angular range covered by the optical element will receive the multiplexed signal.

In this example, each of the second, third and fourth FSO network nodes 404, 406, 408 is within the angular range of the optical element 104 of the first FSO network node 402. Each of the second, third and fourth FSO network nodes 404, 406, 408 includes an optical element 104, a splitter 312 and a multiplexor 318. The second FSO network node 404 comprises an optical device 410 configured to select the first subset of wavelengths λ₁ from the plurality of wavelengths in the multiplexed signal, and an optical module 412 for receiving the first subset of wavelengths λ₁. The third FSO network node 406 comprises an optical device 414 configured to select the second subset of wavelengths λ₂ from the plurality of wavelengths in the multiplexed signal, and an optical module 416 for receiving the second subset of wavelengths λ₂. The fourth FSO network node 408 comprises an optical device 418 configured to select the third subset of wavelengths λ₃ from the plurality of wavelengths in the multiplexed signal, and an optical module 420 for receiving the third subset of wavelengths λ₃.

Thus, in the example shown in FIG. 4, the hub node (i.e., the first network node 402) is configured to receive and transmit all of the subsets of wavelengths that are used within the network 400, thereby enabling it to communicate with each of the spoke nodes (i.e., the second, third and fourth FSO network nodes 404, 406, 408), each of which is configured to receive and transmit in a respective one of the subsets of wavelengths used in the network. In this way, the FSO network node 404, 406, 408 are able only to communicate with the first FSO network node 402, and not with one another.

As discussed above, since the optical device and the optical module of each FSO network node form part of a removable optical unit (e.g., a pluggable optical unit), additional optical devices and optical modules could be added to each of the second, third and fourth FSO network nodes 404, 406, 408 in order to scale up the network, and to enable communications between those nodes. Similarly, one or more additional FSO network nodes may be added into the network 400, and additional optical devices and optical modules configured to a particular subset of wavelengths may be added to one or more of the other FSO network nodes in the network.

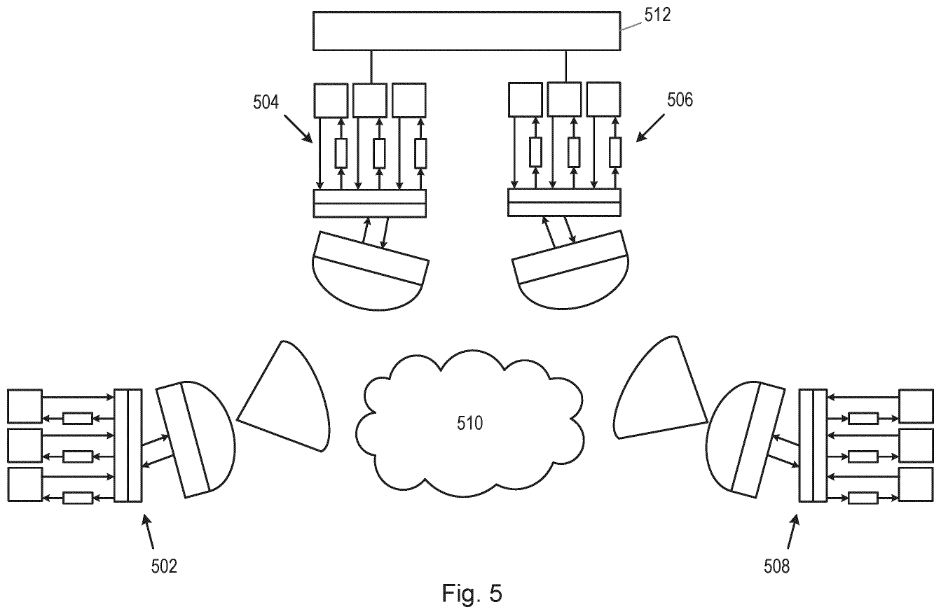

FIG. 5 is a schematic illustration of a further example of an FSO network 500. In this example, the FSO network 500 includes four FSO network nodes, 502, 504, 506 and 508. Each of the FSO network nodes, 502, 504, 506 and 508 in this example is configured to transmit and receive all of the subsets of wavelengths used in the network 500. In this example, an obstacle or obstruction (e.g., a wall or building) 510 is located between the node 502 and the node 508, preventing direct communication between those nodes. Thus, communication between node 502 and node 508 may be made via the nodes 504 and 506. In one example, the node 504 and node 506 may be connected to one another via a connection 512, such that the node 504 receives a signal from the node 502, transmits the signal via the connection 512 to the node 506, and the node 506 transmits the signal to the node 508. An advantage of positioning to nodes adjacent to one another within the network 500 is that the angular range can be covered by the pair of nodes is greater than the angular range that can be covered by a single node. In an alternative example, a single node may be provided with multiple optical element 104. For example, a first optical element may receive the signal from the node 502 and a second optical element may be used to direct the signal towards the node 508.

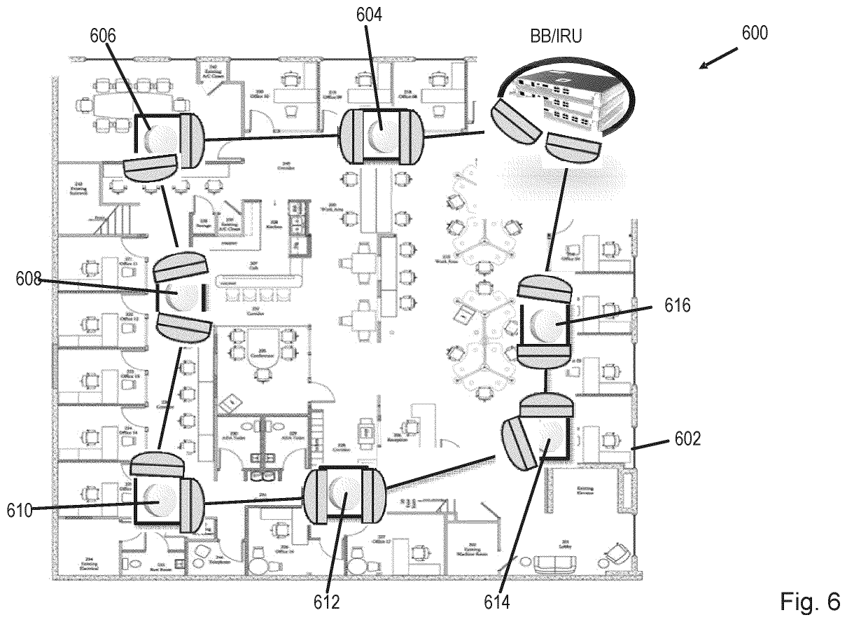

FIG. 6 is a schematic illustration of a further example of an FSO network 600. In this example, the FSO network 600 is distributed within a building 602. The network 600 includes eight FSO network nodes 604 to 618, each located at a different position around the building 602. The nodes are connected in series, such that each node is able to communicate with just its two adjacent nodes. The nodes are configured such that a different subset of wavelengths is used for signals transmitted between each adjacent pair of nodes. In other words, nodes and 604 and 606 are configured to communicate using a first subset of wavelengths, nodes 606 and 608 are configured to communicate using a second subset of wavelengths, nodes 608 and 610 are configured to communicate using a third subset of wavelengths, and so on. In this way, the likelihood of interference between signals transmitted by different nodes in the network 600 is greatly reduced.

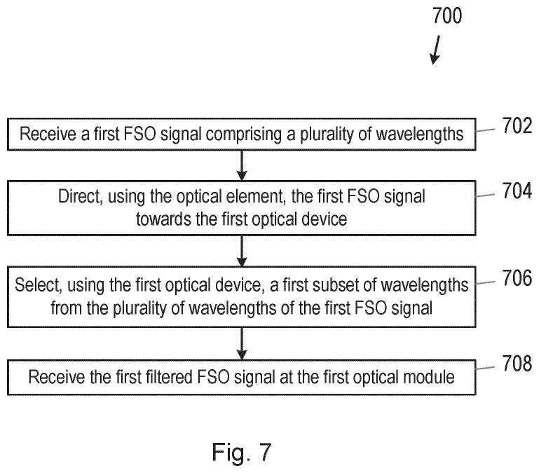

According to various examples of the present disclosure, a method is provided. FIG. 7 is a flowchart illustrating process steps in an example of a method 700 performed by an FSO network node. The FSO network node (e.g., the FSO network node 100, 300, 400) as an optical element (e.g., the optical element 104), a first optical device (e.g., the optical device 106, 306, 406) and a first optical module (e.g., the optical module 108, 308, 408). The method 700 comprises, at step 702, receiving a first FSO signal comprising a plurality of wavelengths. At step 704, the method 700 comprises directing, using the optical element, the first FSO signal towards the first optical device. The method 700 comprises, at step 706, selecting, using the first optical device, a first subset of wavelengths from the plurality of wavelengths of the first FSO signal. At step 708, the method 700 comprises receiving the first subset of wavelengths at the first optical module.

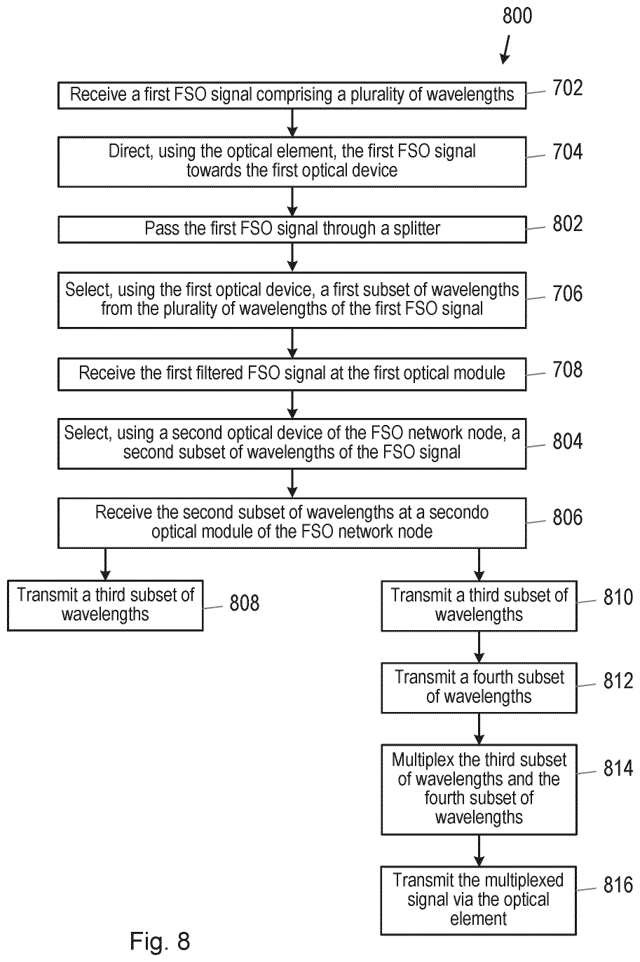

FIG. 8 is a flowchart illustrating process steps in a further example of a method 800 performed by an FSO network node. The method 800 includes the steps discussed above with regard to the method 700. In some examples, the method 800 may further comprise at step 802, passing the first FSO signal through a splitter of the FSO network node, to split the first FSO signal into a first split FSO signal to be acted upon by the first optical device and a second split FSO signal to be acted upon by the second optical device. The optical devices comprise, or function as, filters, the first split FSO signal may be filtered by the first optical device, and the second split FSO signal may be filtered by the second optical device. At step 804, the method 800 may further comprise selecting, using a second optical device (e.g., the optical device 306) of the FSO network node, a second subset of wavelengths from the plurality of wavelengths of the first FSO signal. The method 800 may comprise, at step 806, receiving the second subset of wavelengths at a second optical module (e.g., the optical module 308) of the FSO network node.

As noted above, the FSO network nodes disclosed herein may also configured to transmit signals. As such, in a network node having just one optical module (e.g., the network node 100 shown in FIG. 1) the method 800 may further comprise, at step 808, transmitting, using the first optical module of the FSO network node, a third set of wavelengths via the optical element.

In a network node having multiple optical modules (e.g., the network node 300 shown in FIG. 3 or the network node 400 shown in FIG. 4), the method 800 may further comprise, at step 810, transmitting, using the first optical module of the FSO network node, a third set of wavelengths. At step 812, the method 800 may comprise transmitting, using the second optical module of the FSO network node, a fourth set of wavelengths. The method 800 may comprise, at step 814, multiplexing, using a multiplexer of the FSO network node, the third set of wavelengths and fourth set of wavelengths to form a multiplexed signal. At step 816, the method 800 may comprise transmitting the multiplexed signal via the optical element.

In some examples, steps of the methods 700, 800 may be performed by an FSO network node as described herein.

An advantage of using WDM technology in an FSO network is that multiple discrete subsets of wavelengths can be used for communications between different pairs or sets of network nodes. The subsets of wavelengths used can be allocated such that communications between one pair/set of network nodes do not interfere with communications between another pair/set of network nodes. The allocation of a subset of wavelengths to be used by a network node may be made by the network node itself during a setup or calibration phase. Such a calibration may be performed for example when a network node is first switched on or added to an FSO network. In some examples, the calibration may be repeated even when the network node is in service (e.g., in use in an FSO network), in order to ensure that a subset of wavelengths allocated to a particular network node do not interfere with subsets of wavelengths used by network node that may have been added into the FSO network.

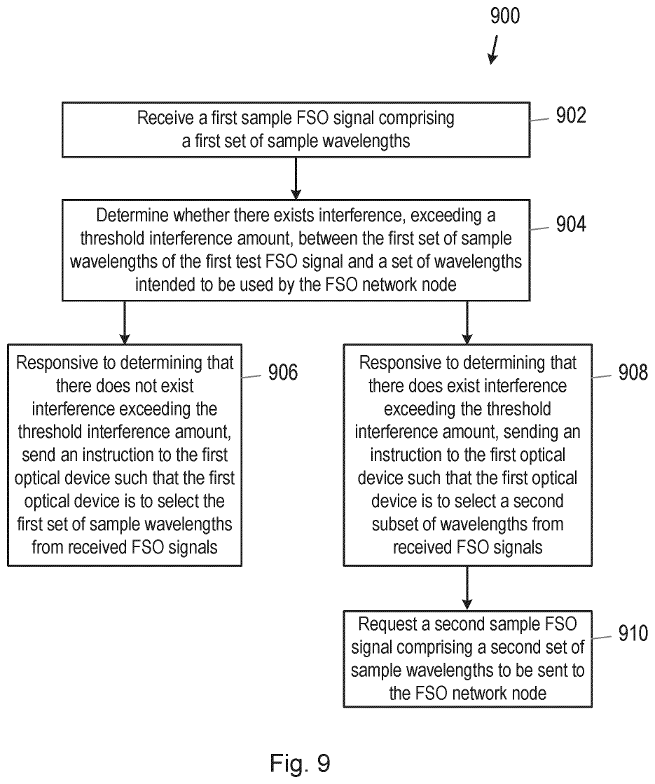

FIG. 9 is a flowchart illustrating process steps in a further example of a method 900 of calibrating an FSO network node, such as the FSO network nodes 100, 300, 400 disclosed herein. The method 900 comprises, at step 902, receiving a first sample FSO signal comprising a first set of sample wavelengths. The first sample FSO signal may, for example, comprise an FSO signal transmitted by another node (e.g., a node that is already in service) in the network, which is capable of transmitting a signal to the FSO network node to be calibrated. At step 904, the method 900 comprises determining whether there exists interference, exceeding a threshold interference amount, between the first set of sample wavelengths and a set of wavelengths intended to be used by the FSO network node. For example, the network node may have a default set of wavelengths that it intends to use, or the network node may be provided (e.g., by an operator) with a set of wavelengths intended to be used. At step 906, the method 900 comprises, responsive to determining that there does not exist interference exceeding the threshold interference amount, sending an instruction to the first optical device such that the first optical device is to select the first set of sample wavelengths from received FSO signals. In other words, if there is no interference between the received first set of sample wavelengths and the set of wavelengths intended for use by the FSO network node, or if the level of interference is below the defined interference threshold, then it can be determined that it is appropriate to use the intended set of wavelengths, and the first optical device may be configured as such. In some examples, the first optical module may also be configured to receive wavelengths corresponding to the intended set of wavelengths.

In the event that the first set of sample wavelengths and the set of wavelengths intended to be used by the FSO network node are the same, overlap, or otherwise interfere with one another, then the first optical device and/or the first optical module may be configured to operate with a different set of wavelengths. For example, the method 900 may comprise, at step 908, responsive to determining that there does exist interference exceeding the threshold interference amount, sending an instruction to the first optical device such that the first optical device is to select a second subset of wavelengths from received FSO signals. In some examples, an optical module (e.g., a transceiver) of an FSO network node may be used to determine the amount of interference. For example, an optical module may detect a high bit error rate (BER) that exceeds its forward error correction (FEC) threshold, and this may suggest an unacceptable level of interference. At step 910, the method 900 may comprise requesting a second sample FSO signal comprising a second set of sample wavelengths to be sent to the FSO network node

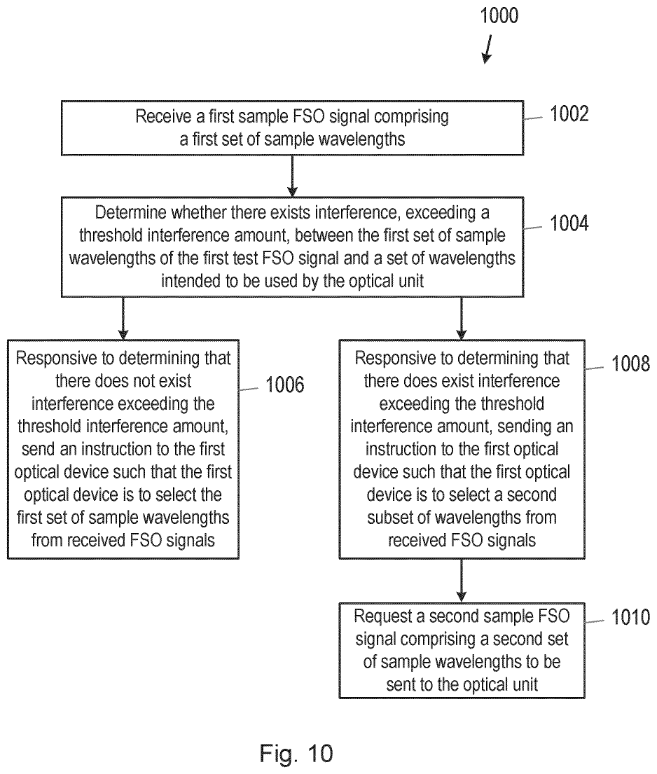

A similar calibration technique may be applied to individual pluggable optical units, such as the optical unit 200 shown in FIG. 2. FIG. 10 is a flowchart illustrating process steps in a further example of a method 1000 of calibrating an optical unit, such as the optical unit 200. At step 1002, the method 1000 comprises receiving a first sample FSO signal comprising a first set of sample wavelengths. As above, the first sample FSO signal may, for example, comprise an FSO signal transmitted by another node (e.g., a node that is already in service) in the network, which is capable of transmitting a signal to the FSO network node to be calibrated. The method 1000 further comprises, at step 1004, determining whether there exists interference, exceeding a threshold interference amount, between the first set of sample wavelengths and a set of wavelengths intended to be used by the optical unit. At step 1006, the method 1000 further comprises, responsive to determining that there does not exist interference exceeding the threshold interference amount, sending an instruction to the optical device such that the optical device is to select the first set of sample wavelengths from received FSO signals.

The method 1000 may further comprise, at step 1008, responsive to determining that there does exist interference exceeding the threshold interference amount, sending an instruction to the optical device such that the first optical device is to select a second subset of wavelengths from received FSO signals. The level of interference may be determined in the manner described above. At step 1010, the method 1000 may further comprise requesting a second sample FSO signal comprising a second set of sample wavelengths to be sent to the optical unit.

Examples of the present disclosure thus provide a mechanism by which communications may be made between FSO network nodes of an FSO network in a way that does not require highly accurate alignment of one node relative to another. The use of an optical element, such as a lens in the FSO network node effectively distributes a transmitted FSO signal over a wide angular range, such that the signal can be received by FSO network nodes position within that angular range relative to the transmitting node. The use of configurable optical devices (e.g., filters) and optical modules (e.g., transceivers) enables defined subsets of wavelengths to be received by different nodes in the network or by the same node, thereby reducing the likelihood of a difference between the signals.

Examples of the present disclosure may be implemented as part of an FSO backhaul architecture in an indoor or outdoor environment. For example, the present disclosure may be used to carry backhaul traffic over wireless connections. An FSO network as disclosed herein may be used in complex indoor installations where line-of-sight limitations restrict the use of traditional laser-based communications. Similarly, such an FSO network may be implemented in an outdoor environment such as a temporary outdoor event, where no existing infrastructure exists.

Use of WDM and wavelength selection/filtering enables subset of wavelengths to be reused within an FSO network when there is little or no interference between a signal being transmitted in the subset of wavelengths and other signals using the same subset of wavelengths elsewhere in the network.

Various wavebands may be used for communications in the FSO network including, for example, wavelengths in the O-band (original band), between 1260 nm and 1360 nm, and wavelengths in the C-band (conventional band), between 1530 nm and 1565 nm. With these wavelengths, it may be possible to use commercially available optical components (e.g., optical devices and optical modules), particularly in the small-scale installations (e.g., networks including between 8 and 24 nodes).

The use of configurable or tunable optical devices (e.g., filters) and optical modules (e.g., transceivers) provides operational and supply flexibility.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-18. (canceled)

19. A free space optical (FSO) network node configured to receive and/or transmit a first FSO signal comprising a plurality of wavelengths, the FSO network node comprising:
an optical element configured to receive the first FSO signal from within a defined angular range;
a first optical device configured to select a first subset of wavelengths from the plurality of wavelengths of the first FSO signal; and
a first optical module configured to receive the first subset of wavelengths from the first optical device.

20. The FSO network node of claim 19, wherein the first optical device comprises a configurable wavelength selector.

21. The FSO network node of claim 19, further comprising:
a second optical device configured to select a second subset of wavelengths from the plurality of wavelengths of the first FSO signal; and
a second optical module configured to receive the second subset of wavelengths from the second optical device.

22. The FSO network node of claim 21, wherein the second optical device comprises a configurable wavelength selector.

23. The FSO network node of claim 21, further comprising:
a signal splitter configured to split the first FSO signal into a first split FSO signal to be acted upon by the first optical device and a second split FSO signal to be acted upon by the second optical device.

24. The FSO network node of claim 19, wherein the first optical module is further configured to transmit a third subset of wavelengths via the optical element.

25. The FSO network node of claim 21,
wherein the first optical module is further configured to transmit a third subset of wavelengths;
wherein the second optical module is further configured to transmit a fourth subset of wavelengths; and
wherein the FSO network node further comprises:
a multiplexing module configured for:
multiplexing the third subset of wavelengths and the fourth subset of wavelengths to form a multiplexed signal; and
transmitting the multiplexed signal via the optical element.

26. The FSO network node of claim 19, wherein the optical element comprises a lens.

27. The FSO network node of claim 26, wherein the lens comprises has an angular range of up to 120 degrees.

28. The FSO network node of claim 19, wherein the FSO network node is configured to be connected to a wireless communication network, the wireless communication network comprising a 3^{rd} Generation Partnership Project (3GPP) radio communication network that includes radio equipment.

29. A method performed by a free space optic (FSO) network node, the FSO network node having an optical element, a first optical device and a first optical module, the method comprising:
receiving a first FSO signal comprising a plurality of wavelengths;
directing, using the optical element, the first FSO signal towards the first optical device;
selecting, using the first optical device, a first subset of wavelengths from the plurality of wavelengths of the first FSO signal; and
receiving the first subset of wavelengths at the first optical module.

30. The method of claim 29, further comprising:
selecting, using a second optical device of the FSO network node, a second subset of wavelengths from the plurality of wavelengths of the first FSO signal; and
receiving the second subset of wavelengths at a second optical module of the FSO network node.

31. The method of claim 30, further comprising:
passing the first FSO signal through a splitter of the FSO network node, to split the first FSO signal into a first split FSO signal to be acted upon by the first optical device and a second split FSO signal to be acted upon by the second optical device.

32. The method of claim 29, further comprising:
transmitting, using the first optical module of the FSO network node, a third set of wavelengths via the optical element.

33. The method of claim 29, further comprising:
transmitting, using the first optical module of the FSO network node, a third set of wavelengths;
transmitting, using the second optical module of the FSO network node, a fourth set of wavelengths;
multiplexing, using a multiplexer of the FSO network node, the third set of wavelengths and fourth set of wavelengths to form a multiplexed signal; and
transmitting the multiplexed signal via the optical element.

34. A method of calibrating a free space optical (FSO) network node according to claim 19, the method comprising:
receiving a first sample FSO signal comprising a first set of sample wavelengths;
determining whether there exists interference, exceeding a threshold interference amount, between the first set of sample wavelengths and a set of wavelengths intended to be used by the FSO network node;
responsive to determining that there does not exist interference exceeding the threshold interference amount, sending an instruction to the first optical device such that the first optical device is to select the first set of sample wavelengths from received FSO signals.

35. The method of claim 34, further comprising:
responsive to determining that there does exist interference exceeding the threshold interference amount, sending an instruction to the first optical device such that the first optical device is to select a second subset of wavelengths from received FSO signals; and
requesting a second sample FSO signal comprising a second set of sample wavelengths to be sent to the FSO network node.

36. A free space optical (FSO) network comprising:
a first FSO network node according to claim 19; and
a second FSO network node according to claim 19.
